(19) United States
(12) Patent Application Publication
(10) Pub. No.: US 2016/0266446 A1
(43) Pub. Date: Sep. 15, 2016

(54) LIQUID CRYSTAL DISPLAY DEVICE AND MANUFACTURING METHOD THEREOF

(71) Applicant: Samsung Display Co., Ltd., Yongin-si (KR)

(72) Inventors: Dan Bi YANG, Gunpo-si (KR); Min-Joo HAN, Seoul (KR); Ji Phyo HONG, Pyeongtaek-si (KR); Dong Han SONG, Hwaseong-si (KR); Ki Chul SHIN, Seongnam-si (KR); Jae Hoon JUNG, Anyang-si (KR)

(21) Appl. No.: 14/850,689

(22) Filed: Sep. 10, 2015

(30) Foreign Application Priority Data
Mar. 9, 2015 (KR) 10-2015-0032772

(51) Int. Cl. G02F 1/1343; G02F 1/1341

(52) U.S. Cl. CPC G02F 1/134309; G02F 1/1341

(57) ABSTRACT

A liquid crystal display of the present system and method includes: a lower substrate including a plurality of pixel areas; an upper substrate formed with a common electrode; a liquid crystal layer interposed between the lower substrate and the upper substrate; and first and second pixel electrodes respectively positioned in a plurality of pixel areas, wherein the second pixel electrode is positioned in a region including a center axis of each pixel area, and the first pixel electrode is positioned in a left side and a right side of the second pixel electrode.

### CROSS-REFERENCE TO RELATED APPLICATION

This application claims priority to and the benefit of Korean Patent Application No. 10-2015-0032772 filed in the Korean Intellectual Property Office on Mar. 9, 2015, the entire contents of which are incorporated herein by reference.

### BACKGROUND OF THE DISCLOSURE

(a) Field of the Disclosure

The present disclosure relates to a liquid crystal display and a manufacturing method thereof.

(b) Description of the Related Art

A liquid crystal display is a type of flat panel displays that are now widely used. The liquid crystal display includes two display panels in which field generating electrodes, such as pixel electrodes and a common electrode, are formed, and a liquid crystal layer interposed between the display panels. In the liquid crystal display, a voltage is applied to the field generating electrodes to generate an electric field in the liquid crystal layer, which determines the direction of liquid crystal (LC) molecules of the liquid crystal layer, and an image is displayed by controlling the polarization of incident light.

Among the LCDs, a vertical alignment (VA) mode LCD, which aligns LC molecules such that their long axes are perpendicular to the panels in the absence of an electric field, is popular because of its high contrast ratio and wide reference viewing angle.

In the vertical alignment (VA) mode LCD, the wide reference viewing angle may be realized by forming a plurality of domains including liquid crystal molecules of different alignment directions in one pixel.

As one example of forming the plurality of domains in one pixel, there is a method of forming cutouts of minutes slits in the field generating electrodes.

As examples, liquid crystal displays having a domain-forming member include a VA mode liquid crystal display having domain-forming members formed at both of the upper and lower substrates, and a patternless VA mode liquid crystal display having minute patterns formed only at a lower substrate without forming patterns on an upper substrate. A display area is sectored into a plurality of domains by the domain-forming members, and liquid crystal molecules in each domain are inclined in the same direction.

Recently, a method of providing a pretilt to the liquid crystal molecules in the absence of an electric field has been developed to improve the response speed of the liquid crystal while realizing a wide viewing angle. For the liquid crystal molecules to have the pretilt of the various directions, alignment layers having various alignment directions may be used, or an alignment aid may be added and hardened to pretilt the liquid crystal molecules of the liquid crystal layer after applying the electric field to the liquid crystal layer. The alignment aid hardened by heat or light, such as ultraviolet rays, may provide the pretilt to the liquid crystal molecules in a predetermined direction. To generate the electric field in the liquid crystal layer, the voltage is respectively applied to the field generating electrodes.

The above pretilt formation process is called an electric field exposure process. A curved liquid crystal panel may be generated by applying an external force to the flat liquid crystal panel after the electric field exposure process is completed.

However, since the relative arrangement of the upper substrate and the lower substrate is slightly moved in a right/left direction, a pretilt angle formed to the liquid crystal near the upper substrate and a pretilt angle formed to the liquid crystal near the lower substrate are changed (referring to FIG. 6), and a texture or stain may be generated in a region where the pretilt angle of the upper substrate and the pretilt angle of the lower substrate are different.

The above information disclosed in this Background section is only for enhancement of understanding of the background of the disclosure and therefore may contain information that does not form the prior art that is already known in this country to a person of ordinary skill in the art.

### SUMMARY

The present disclosure provides a liquid crystal display in which a texture or a stain due to misalignment of pretilt angles is not formed, and a manufacturing method thereof.

A liquid crystal display according to an exemplary embodiment of the present disclosure includes: a lower substrate including a plurality of pixel areas; an upper substrate formed with a common electrode; a liquid crystal layer interposed between the lower substrate and the upper substrate; and first and second pixel electrodes respectively positioned in a plurality of pixel areas, wherein the second pixel electrode is positioned in a region including a center axis of each pixel area, and the first pixel electrode is positioned at a left side and a right side of the second pixel electrode.

Only liquid crystal molecules of a region corresponding to the first pixel electrode may be pretilted.

The first and second pixel electrodes may respectively be patterned to include a plurality of branch electrodes or a plurality of slits.

When expressing a gray depending on image data, the first pixel electrode may be applied with a first voltage, the second pixel electrode may be applied with a second voltage, and the first voltage may be larger than the second voltage.

The pattern of the second pixel electrode may include a left side pattern and a right side pattern, an inclination angle of a left side pattern and an inclination angle of a right side pattern with respect to the center axis may be different from each other, and a pattern of the first pixel electrode positioned in the left side and the right side of the second pixel electrode may respectively have an inclination angle corresponding to an inclination angle of the left side pattern and an inclination angle of the right side pattern.

The liquid crystal display may include a curved display unit, and liquid crystal molecules of a region adjacent to the lower substrate may correspond to liquid crystal molecules of a corresponding region adjacent to the upper substrate. The liquid crystal molecules of the corresponding region may not have a pretilt angle, or may have a pretilt angle that is the same as the pretilt angle of the liquid crystal molecules of the region adjacent to the lower substrate.

A manufacturing method of a liquid crystal display according to an exemplary embodiment of the present system and method includes: forming first and second pixel electrodes respectively positioned in a plurality of pixel areas of a lower substrate; forming a common electrode in an upper substrate; combining the lower substrate and the upper substrate and injecting a liquid crystal therebetween to form a liquid crystal panel; and performing an electric field exposure process, wherein the second pixel electrode is positioned in a region including a center axis of each pixel area, the first pixel electrode is positioned in a left side and a right side of the second pixel electrode, and the electric field exposure process is performed in a state in which a voltage forming the pretilt of the liquid crystal molecule is applied to the first pixel electrode.

The method may further include applying an external force to the liquid crystal panel having undergone the electric field exposure process to form a curved liquid crystal panel.

The method may further include forming first, second, and third transistors, wherein one end of each of the first and second transistors is connected to a data line, a control terminal is connected to a gate line, and another end of the second transistor is connected to one end of the third transistor. The first pixel electrode may be connected to another end of the first transistor, and the second pixel electrode may be connected to the other end of the second transistor.

When performing an electric field exposure process, the voltage may be supplied through the data line, and the gate line may be applied with a ground voltage.

According to an exemplary embodiment of the present system and method, a liquid crystal display in which no texture or stain is generated due to misalignment of the pretilt angles of liquid crystal molecules and a manufacturing method thereof is provided.

### BRIEF DESCRIPTION OF THE DRAWINGS

FIG. 1 is a view of a liquid crystal display according to an exemplary embodiment of the present system and method.

FIG. 2 is a view of one pixel area according to an exemplary embodiment of the present system and method.

FIG. 3 is a circuit diagram of the pixel area of FIG. 2.

FIG. 4A is a view to explain a pretilt angle of a liquid crystal of a flat liquid crystal display of the present system and method.

FIG. 4B is a view to explain a pretilt angle of a liquid crystal of a curved liquid crystal display of the present system and method.

FIG. 5 is a view to explain a voltage applied in an electric field exposure process.

FIG. 6 is a view to explain a misalignment of a pretilt angle of a liquid crystal in a conventional art.

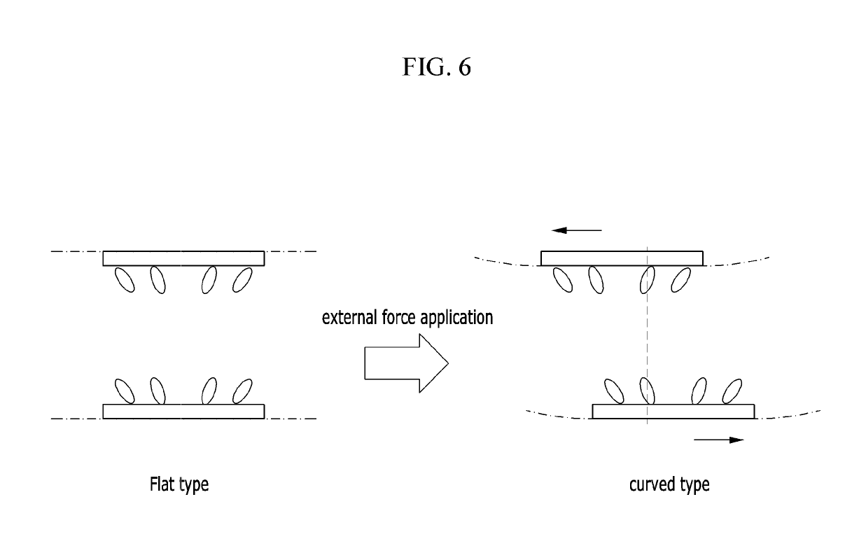

### DETAILED DESCRIPTION OF THE EMBODIMENTS

The present system and method are described more fully hereinafter with reference to the accompanying drawings in which exemplary embodiments of the present system and method are shown. As those skilled in the art would realize, the described embodiments may be modified in various different ways, all without departing from the spirit or scope of the present system and method.

In the drawings, the thickness of layers, films, panels, regions, etc., are exaggerated for clarity. Like reference numerals designate like elements throughout the specification. It is understood that when an element such as a layer, film, region, or substrate is referred to as being “on” another element, it may be directly on the other element, or intervening elements may also be present. In contrast, when an element is referred to as being “directly on” another element, there are no intervening elements present.

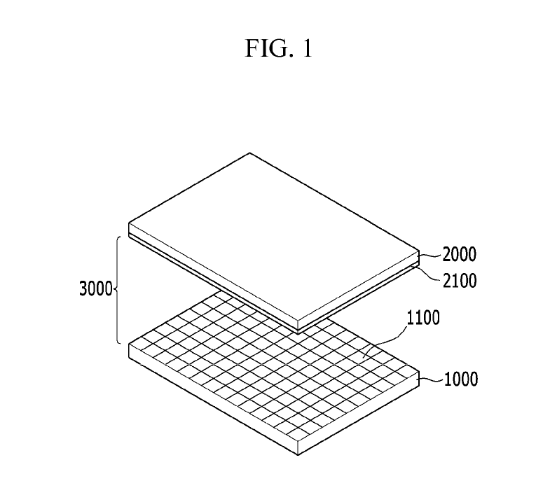

FIG. 1 is a view of a liquid crystal display according to an exemplary embodiment of the present system and method. The liquid crystal display includes a lower substrate 1000, an upper substrate 2000, and a liquid crystal layer 3000 interposed between the two substrates 1000 and 2000.

Although not shown, one of two polarizers (not shown) is provided on the upper substrate 2000, and the other one is provided under the lower substrate 1000. Polarization axes of the two polarizers (not shown) are perpendicular to each other.

The upper substrate 2000 and the lower substrate 1000 may be insulation substrates made of a plastic such as a polyimide.

The liquid crystal layer 3000 is interposed between the lower substrate 1000 and the upper substrate 2000. In detail, the liquid crystal layer 3000 may be interposed between an upper alignment layer coated with the common electrode 2100 of the upper substrate 2000 and a lower alignment layer coated with a structure such as a pixel electrode or a column spacer of the lower substrate 1000.

The liquid crystal molecules may have a pretilt angle through the alignment layer or the alignment aid included in the liquid crystal layer 3000. However, as described later, in the present system and method, the liquid crystal molecules of all portions may have the pretilt angle.

In the present exemplary embodiment, the liquid crystal molecules of the liquid crystal layer 3000 have negative dielectric anisotropy, which means the liquid crystal molecules of the liquid crystal layer 3000 are arranged such that the long axes of the liquid crystal molecules are aligned to be substantially perpendicular to the surfaces of the lower substrate 1000 and the upper substrate 2000 in the absence of an electric field. The liquid crystal molecules having the pretilt angle are inclined with a predetermined inclination angle with respect to a vertical axis so that a black gray is displayed.

When driving the liquid crystal display, an electric field is applied to the liquid crystal molecules, and the liquid crystal molecules are inclined to be close to horizontal, thereby displaying a white gray. That is, the present exemplary embodiment represents a normally black mode (i.e., little or no light is transmitted in the absence of an electric field).

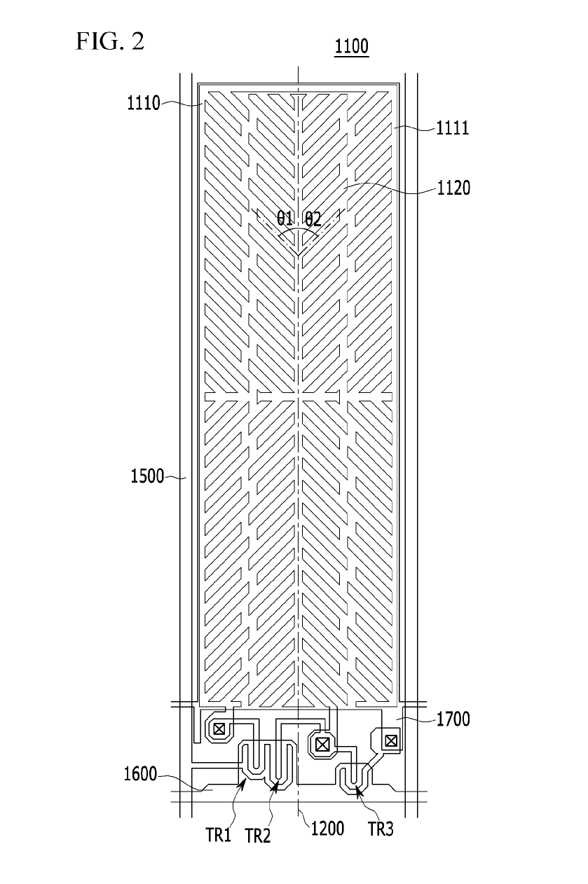

The lower substrate 1000 includes a plurality of pixel areas. Next, in FIG. 2, one pixel area 1100 among the plurality of pixel areas disposed in a matrix shape is described in detail. Other pixel areas have substantially the same structure as the pixel area 1100. However, each pixel area may include one color filter (not shown) among red, green, and blue color filters, and adjacent pixel areas may have filters of different colors from each other.

Light emitted from a backlight (not shown) passes through the described color filters, thereby representing an image to a user through a combination of colors. However, the colors of the color filters may be determined according to the design of the display device. For example, the filter colors are not limited to three primary colors, such as red, green, and blue, but may include one of cyan, magenta, yellow, and white-based colors.

FIG. 2 is a view illustrating one pixel area 1100 according to an exemplary embodiment of the present system and method. FIG. 2 shows a layout of a conductive material to transmit a signal, and an insulating material is not shown.

Referring to FIG. 2, the pixel area 1100 includes a data line 1500, a gate line 1600, a reference voltage line 1700, first pixel electrodes 1110 and 1111, a second pixel electrode 1120, a first transistor TR1, a second transistor TR2, and a third transistor TR3.

The data line 1500 mainly extends in a longitudinal direction and transmits a data voltage received from a data driver (not shown) to one end of the first transistor TR1 and one end of the second transistor TR2.

The gate line 1600 extends in a transverse direction. The gate line 1600 is connected to each control terminal of the first transistor TR1, the second transistor TR2, and the third transistor TR3, and controls the transistors TR1, TR2, and TR3 depending on a gate signal received from a gate driver (not shown).

The reference voltage line 1700 mainly extends in the longitudinal direction and transmits a predetermined voltage such as a common voltage Vcom.

The data line 1500, the gate line 1600, and the reference voltage line 1700 may be formed of a conductive material. For example, they may be configured of a single material such as aluminum (Al), molybdenum (Mo), copper (Cu), a complex material, or a deposition structure.

The first pixel electrode 1110 of a left side is connected to the other end of the first transistor TR1 through a first via hole. The first pixel electrode 1111 of a right side is connected to the same node as the first pixel electrode 1110 of the left side. That is, the first pixel electrodes 1110 and 1111 of the left side and the right side have the same voltage.

The second pixel electrode 1120 is connected to the other end of the second transistor TR2 through a second via hole. The second pixel electrode 1120 is positioned in a region including a center axis 1200 of the pixel area 1100. The first pixel electrodes 1110 and 1111 are respectively positioned at the left side and the right side of the second pixel electrode 1120.

One end of the third transistor TR3 is connected to the other end of the second transistor TR2, and the other end of the third transistor TR3 is connected to the reference voltage line 1700 through a third via hole.

The first pixel electrodes 1110 and 1111 and the second pixel electrode 1120 are respectively patterned to include a plurality of branch electrodes. As another exemplary embodiment, the first pixel electrodes 1110 and 1111 and the second pixel electrode 1120 may be respectively patterned to include a plurality of slits.

In the present exemplary embodiment, the pattern of the second pixel electrode 1120 includes a left side pattern and a right side pattern with reference to the center axis 1200. The inclination angle ƒ₁ of the left side pattern and the inclination angle θ₂ of the right side pattern are different with reference to the center axis 1200, and the pattern of the first pixel electrodes 1110 and 1111 positioned at the left side and the right side of the second pixel electrode 1120 have the inclination angle corresponding respectively to the inclination angle θ₁ of the left side pattern and the inclination angle θ₂ of the right side pattern.

In the present exemplary embodiment, the pixel area 1100 has eight domains. The first pixel electrode 1110 has two domains upward and downward (with respect to the orientation shown in FIG. 2), the second pixel electrode 1120 has two domains upward and two domains downward, and the first pixel electrode 1111 has two domains upward and downward.

A person of ordinary skill in the art may change the design by subdividing the direction of the plurality of branch electrodes to have more domains.

The connection relation and the circuit configuration of the transistors TR1, TR2, and TR3 and the pixel electrodes 1110, 1111, and 1120 may be differently designed.

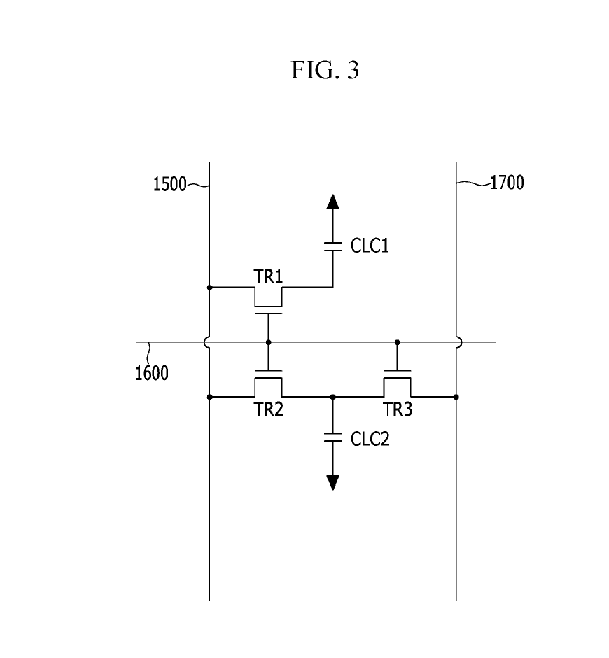

FIG. 3 is a circuit diagram of the pixel area 1100 of FIG. 2.

The first pixel electrode 1110 and 1111 and the common electrode 2100 form a first liquid crystal capacitor CLC1, and the second pixel electrode 1120 and the common electrode 2100 form a second liquid crystal capacitor CLC2.

An exemplary light emission driving sequence according to the circuit diagram of FIG. 3 is as follows.

Firstly, if an on-level voltage is applied to a gate line 1600, the first transistor TR1, the second transistor TR2, and the third transistor TR3 are turned on.

Accordingly, the data voltage applied to the data line 1500 is respectively applied to the first pixel electrodes 1110 and 1111 and the second pixel electrode 1120 through the first transistor TR1 and the second transistor TR2 that are turned on.

The first liquid crystal capacitor CLC1 is charged with a difference of the data voltage and the common voltage. The second liquid crystal capacitor CLC2 is charged with a difference of the data voltage and the common voltage that is further is divided through the third transistor TR3. Accordingly, the voltage charged in the second liquid crystal capacitor CLC2 is smaller than the voltage charged to the first liquid crystal capacitor CLC1.

Resultantly, the slope of the liquid crystal molecules of the region near the first pixel electrodes 1110 and 1111 and the slope of the liquid crystal molecules of the region near the second pixel electrode 1120 have a difference, thereby improving lateral visibility.

The voltage applied to the reference voltage line 1700 may be larger than the common voltage.

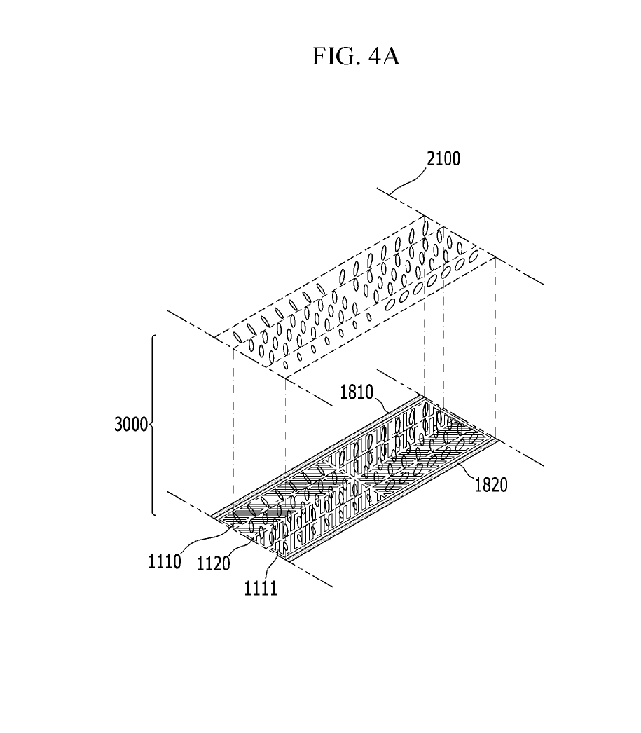

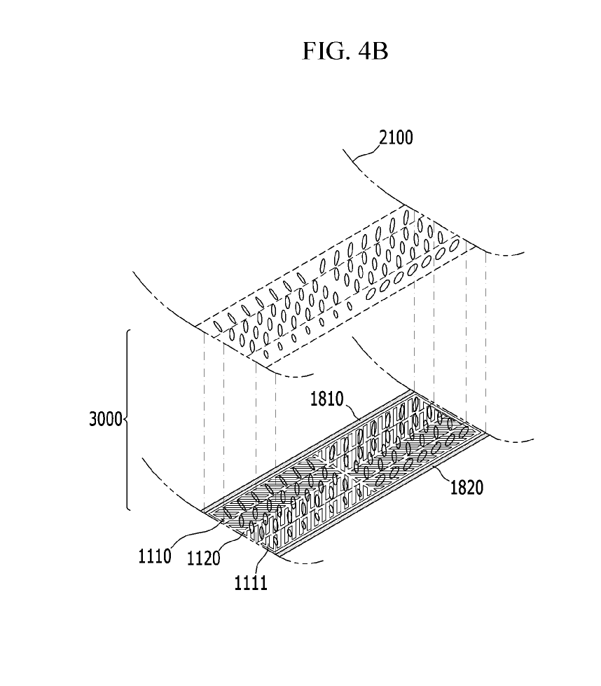

FIG. 4A and FIG. 4B are views to explain the pretilt angle of the liquid crystal molecules of the flat and curved liquid crystal displays of the present system and method.

FIGS. 4A and 4B show the common electrode 2100, the first and second pixel electrodes 1110, 1111, and 1120, the liquid crystal layer 3000, and the black matrix 1810 and 1820 corresponding to the pixel area 1100 as the only required configurations for the explanation.

Before the detailed description for each drawing, the manufacturing process of the liquid crystal display is schematically described as follows.

The transistors TR1, TR2, and TR3 are respectively formed in the plurality of pixel areas of the lower substrate 1000, and a metal layer is deposited and patterned for the first and second pixel electrodes 1110, 1111, and 1120 to be connected to the corresponding transistors.

The common electrode 2100 is formed on the upper substrate 2000, and the lower substrate 1000 and the upper substrate 2000 are combined to each other.

Next, the liquid crystal is injected and sealed to form the liquid crystal layer 3000.

Also, after a predetermined voltage is applied to each field generating electrode, an electric field exposure process to form the pretilt angle by hardening an alignment aid through exposure is provided.

Next, the curved liquid crystal panel having the desired curvature may be formed by applying the external force.

FIG. 4A is a view showing the pixel area 1100 of the flat liquid crystal panel according to an exemplary embodiment of the present system and method, before applying the external force and after the electric field exposure process.

Referring to FIG. 4A, the liquid crystal molecules of the region corresponding to the second pixel electrode 1120 do not have the pretilt angle, and their long axis is oriented in the vertical direction. This is because a small voltage (e.g., ˜0V) is applied to the second pixel electrode 1120 in the electric field exposure process such that no electric field is formed between the second pixel electrode 1120 and the common electrode 2100.

As a result, because the liquid crystal molecules near the common electrode 2100 corresponding to the region of the second pixel electrode 1120 are not affected by the nonexistent electric field, the liquid crystal molecules in that region do not have the pretilt angle.

The liquid crystal molecules of the region corresponding to the first pixel electrodes 1110 and 1111 of the left side and the right side, on the other hand, have their long axis inclined in a predetermined angle in the extending direction of the corresponding branch electrode, thereby forming the pretilt angle. This is because the voltage applied to the first pixel electrodes 1110 and 1111 in the electric field exposure process causes an electric field to be formed between the first pixel electrodes 1110 and 1111 and the common electrode 2100.

As a result, because the liquid crystal molecules near the common electrode 2100 corresponding to the region of the first pixel electrode 1110 and 1111 are affected by the electric field between the common electrode 2100 and the first pixel electrode 1110 and 1111, the liquid crystal molecules in that region have the same pretilt angle.

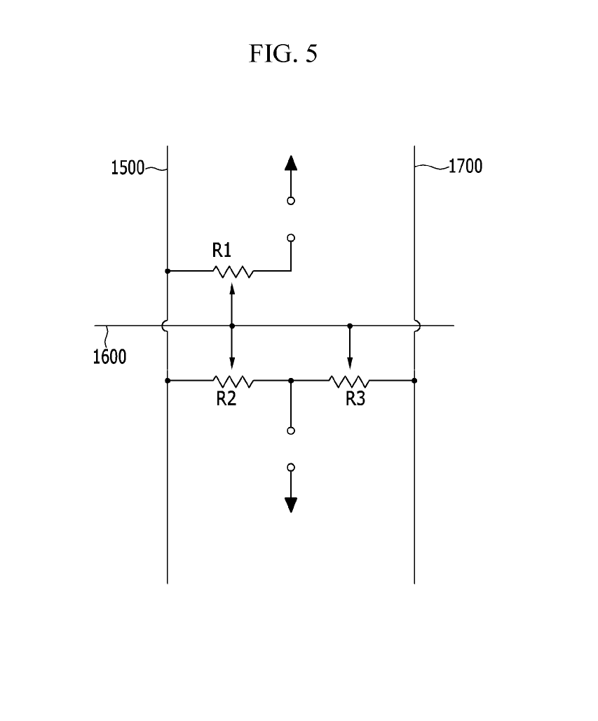

In the electric field exposure process, a method of applying the different voltages to the first pixel electrodes 1110 and 1111 and the second pixel electrode 1120 is as follows. The magnitude and the polarity of the applied voltage may be changed depending on the kind of the transistor and the circuit configuration. FIG. 3 and FIG. 5 are now described. FIG. 5 is a view to explain a voltage applied in an electric field exposure process.

A DC voltage of the positive polarity is applied to the data line 1500. Also, a ground voltage is applied to the gate line 1600, the reference voltage line 1700, and the common electrode 2100.

In this case, the transistors TR1, TR2, and TR3 have a small voltage value Vgs, thereby acting as resistors R1, R2, and R3. Also, since the data voltage is the DC voltage, the current does not flow to the liquid crystal capacitors CLC1 and CLC2, thereby they are opened.

Accordingly, one end of the first resistor R1 is connected to the data line 1500 and the other end thereof is in an opened state. Therefore, the DC voltage is transmitted as it is to the other end of the first resistor R1 connected to the first pixel electrode 1110 and 1111. Resultantly, the electric field is generated between the first pixel electrode 1110 and 1111 and the common electrode 2100.

The value of the second resistor R2 is larger than the value of the third resistor R3. In detail, a negative bias voltage is applied as the voltage Vgs of the second transistor TR2, and 0 V is applied as the voltage Vgs of the third transistor TR3. Since the resistance of the transistor is very much increased when the negative bias voltage is applied, the second resistor R2 has a very much larger resistance value than the third resistor R3.

For example, if a negative bias voltage of about −8 V is applied as the voltage Vgs, the second resistor R2 may have a resistance value of 1014 ohms. If the voltage of 0 V is applied as the voltage Vgs, the third resistor R3 may have a resistance value of 107 ohms. The above values may be changed depending on the design and the kind of the transistor.

Accordingly, the voltage is mainly applied to the second resistor R2, and a voltage near 0 V is applied to the second pixel electrode 1120. Resultantly, no electric field is generated between the second pixel electrode 1120 and the common electrode 2100.

If the electric field exposure process is performed in the state during which the above-described electric field is applied, the liquid crystal molecules of the region corresponding to the second pixel electrode 1120 do not have the pretilt angle, and the liquid crystal molecules of the region corresponding to the first pixel electrodes 1110 and 1111 have the pretilt angle.

FIG. 4B is a view showing the pixel area 1100 of the curved liquid crystal panel according to an exemplary embodiment of the present system and method formed by applying an external force to the flat liquid crystal panel of FIG. 4A.

In the process of applying the external force, the relative arrangement of the upper substrate 2000 and the lower substrate 1000 is changed. That is, compared with FIG. 4A, the upper substrate 2000 and the lower substrate 1000 may be slightly moved in the right/left direction. In the exemplary embodiment of FIG. 4B, the upper substrate 2000 is moved to the left relative to the lower substrate 1000.

In the present system and method, since the pretilt angle is not formed in the liquid crystal molecules of the region corresponding to the second pixel electrode 1120 positioned at the center of the pixel area 1100, a texture or stain is not generated even though the upper and lower substrates 1000 and 2000 are curved.

That is, although the upper and lower substrates 1000 and 2000 are curved, the pretilt angle of the liquid crystal molecules near the pixel electrodes 1110, 1111, and 1120 and the pretilt angle of the liquid crystal molecules near the common electrode 2100 are not misaligned with each other.

Referring to FIG. 4B, the liquid crystal molecules on the first pixel electrode 1110 of the left side have the pretilt angle in the left direction. The liquid crystal molecules of the region of the common electrode 2100 corresponding vertically to the region of the first pixel electrode 1110 include the liquid crystal molecules having the pretilt angle in the left side and the liquid crystal molecules without the pretilt angle.

In the driving process of the liquid crystal display, a response speed of the liquid crystal molecules having the left pretilt angle may be faster than the response speed of the liquid crystal molecules without the pretilt angle. However, because the pretilt angles of the liquid crystal molecules in the upper and lower substrates 1000 and 2000 are not misaligned with each other, no texture or stain is generated.

The liquid crystal molecules on the second pixel electrode 1120 do not have the pretilt angle. The liquid crystal molecules of the region of the common electrode 2100 corresponding vertically to the region of the second pixel electrode 1120 include the liquid crystal molecules without the pretilt angle and the liquid crystal molecules having the pretilt angle in the right side.

In the driving process of the liquid crystal display, the liquid crystal molecules affected by the electric field on the second pixel electrode 1120 according to the pattern of the branch electrode of the second pixel electrode 1120 are inclined rightward and leftward. In this case, the response speed of the liquid crystal molecules having the pretilt angle may be faster than the response speed of the liquid crystal molecules without the pretilt angle. However, because the liquid crystal molecules having the pretilt angle opposite to the direction of the branch electrodes do not exist, no texture or stain is generated.

The liquid crystal molecules of the first pixel electrode 1111 of the right side have the right pretilt angle. The liquid crystal molecules of the region of the common electrode 2100 corresponding vertically to the region of the first pixel electrode 1111 include the liquid crystal molecules having the right pretilt angle and the liquid crystal molecules without the pretilt angle. Here, the liquid crystal molecules without the pretilt angle include the liquid crystal molecules corresponding to the region of the black matrix 1820 in the electric field exposure process. By the same principle, no texture or stain is generated.

The drawings referred to up to now and the detailed description of the present system and method described thus are illustrative of the present system and method and are used only for describing the present system and method. They are not for confining the meaning or limiting the scope of the present system and method recited in the claims. Accordingly, it is understood by those skilled in the art that various modifications and other equivalent exemplary embodiments are possible. Therefore, the true technical protection range of the present system and method should be determined by the technical spirit of the claims.

### DESCRIPTION OF SYMBOLS

1000: lower substrate
1100: pixel area
1110, 1111: first pixel electrode
1120: second pixel electrode
1500: data line
1600: gate line
1700: reference voltage line
2000: upper substrate
2100: common electrode
3000: liquid crystal layer

What is claimed is:

1. A liquid crystal display comprising:
a lower substrate including a plurality of pixel areas;
an upper substrate formed with a common electrode;
a liquid crystal layer interposed between the lower substrate and the upper substrate; and
first and second pixel electrodes respectively positioned in the plurality of pixel areas,
wherein the second pixel electrode is positioned in a region including a center axis of each pixel area, and the first pixel electrode is positioned in a left side and a right side of the second pixel electrode.

2. The liquid crystal display of claim 1, wherein
only the liquid crystal molecules of the region corresponding to the first pixel electrode are pretilted.

3. The liquid crystal display of claim 2, wherein
the first and second pixel electrodes are respectively patterned to include a plurality of branch electrodes or a plurality of slits.

4. The liquid crystal display of claim 3, wherein,
when expressing a gray depending on image data,
the first pixel electrode is applied with a first voltage, the second pixel electrode is applied with a second voltage, and
the first voltage is larger than the second voltage.

5. The liquid crystal display of claim 3, wherein,
the pattern of the second pixel electrode includes a left side pattern and a right side pattern, an inclination angle of the left side pattern and an inclination angle of the right side pattern with respect to the center axis are different from each other, and
a pattern of the first pixel electrode positioned in the left side and the right side of the second pixel electrode respectively has an inclination angle corresponding to the inclination angle of the left side pattern and the inclination angle of the right side pattern.

6. The liquid crystal display of claim 5, wherein
the liquid crystal display includes a curved display unit, and
liquid crystal molecules of a region adjacent to the lower substrate correspond to liquid crystal molecules of a corresponding region adjacent to the upper substrate, and
the liquid crystal molecules of the corresponding region do not have a pretilt angle, or have a pretilt angle that is the same as a pretilt angle of the liquid crystal molecules of the region adjacent to the lower substrate.

7. A method for manufacturing a liquid crystal display, comprising:
forming first and second pixel electrodes respectively positioned in a plurality of pixel areas of a lower substrate;
forming a common electrode in an upper substrate;
combining the lower substrate and the upper substrate and injecting liquid crystal therebetween to form a liquid crystal panel; and
performing an electric field exposure process,
wherein the second pixel electrode is positioned in a region including a center axis of each pixel area, the first pixel electrode is positioned in a left side and a right side of the second pixel electrode, and
the electric field exposure process is performed in a state in which a voltage forming the pretilt of the liquid crystal molecules is applied to the first pixel electrode.

8. The method of claim 7, including
applying an external force to the liquid crystal panel having undergone the electric field exposure process to form a curved liquid crystal panel.

9. The method of claim 8, further comprising
forming first, second, and third transistors, wherein one end of each of the first and second transistors is connected to a data line, a control terminal is connected to a gate line, and another end of the second transistor is connected to one end of the third transistor, and
wherein the first pixel electrode is connected to another end of the first transistor, and the second pixel electrode is connected to the other end of the second transistor.

10. The method of claim 9, wherein,
when performing an electric field exposure process,
a voltage is supplied through the data line, and the gate line is applied with a ground voltage.
